(19) United States
(12) Patent Application Publication
(10) Pub. No.: US 2012/0025046 A1
(43) Pub. Date: Feb. 2, 2012

(54) Adjustable Bracket Compliant with VESA Mount of a Display for Securing Input Device

(75) Inventor: CHUN-HAN YEN, Xindian City (TW)

(73) Assignee: OTOUCH TECHNOLOGIES, CO., LTD., Xindian City (TW)

(21) Appl. No.: 12/848,227

(22) Filed: Aug. 2, 2010

(51) Int. Cl. F16M 13/00

(52) U.S. Cl. 248/298.1

(57) ABSTRACT

The present invention discloses an adjustable bracket compliant with VESA mount of a display for securing input device, which comprises: a first arm plate configured for associating with a securing structure of VESA mount of a display, and having a first sliding structure configured for left and right sliding of a second arm plate; the second arm plate having a second sliding structure which is assembled with the first sliding structure, such that the second arm plate can slide left and right in the first arm plate after assembly, and a third sliding structure configured for back and forth sliding of a input device securing plate; a input device securing plate is configured for mounting an input device, and having the fourth sliding structure which is assembled with the third sliding structure, such that the input device securing plate can slide back and forth in the second arm plate after assembly.

### BACKGROUND OF THE PRESENT INVENTION

1. Field of Invention

The present invention relates to a bracket, and particularly to an adjustable bracket compliant with VESA mount of a display for securing an input device.

2. Description of Related Arts

The published US patent application publication No. US20090296997A1, tilted “Method And Apparatus for Securing A Computer,” has disclosed a securing apparatus, which may be mounted on a VESA mount of a display. For example, the securing apparatus may be used to mount with a fingerprint sensor. However, the securing apparatus of US20090296997A1 did not provide the function of back and forth sliding. Thus, when the distance between the VESA mount of a display and the front of the display panel becomes larger, the position of the fingerprint sensor mounted on the securing apparatus relative to the display panel will be located further behind the display panel, and causing inconvenience when the user is using the fingerprint sensor.

The inventor of the present invention has recognized the prior art needs to be improved, so the present invention is provided as an improvement as an adjustable bracket compliant with VESA mount of a display for securing input device.

### SUMMARY OF THE PRESENT INVENTION

The object of the present invention is to provide an adjustable bracket, which is compliant with the displays having different sizes of screens and a VESA mount for mounting an input device.

To this end, the present invention provides an adjustable bracket compliant with VESA mount of a display for securing input device, which comprises: a first arm plate configured for associating with a securing structure for VESA mount of a display, and having a first sliding structure configured for left and right sliding of a second arm plate; the second arm plate having a second sliding structure, wherein the second sliding structure is assembled with the first sliding structure, such that the second arm plate can slide left and right in the first arm plate after assembly, and a third sliding structure configured for back and forth sliding of a input device securing plate; a input device securing plate configured for mounting an input device and having the fourth sliding structure, wherein the fourth sliding structure is assembled with the third sliding structure, such that the input device securing plate can slide back and forth in the second arm plate after assembly.

### BRIEF DESCRIPTION OF THE DRAWINGS

The present invention will become more readily apparent to those ordinarily skilled in the art after reviewing the following detailed description and accompanying drawings, in which:

FIG. 1 shows a perspective view of an adjustable bracket compliant with VESA mount of a display for securing an input device according to the present invention;

FIG. 2 shows an exploded view of an adjustable bracket compliant with VESA mount of a display for securing an input device according to the present invention;

FIG. 3 shows a rear view of an adjustable bracket compliant with VESA mount of a display for securing an input device according to the present invention being installed on VESA mount of a display;

FIG. 4 shows a side view of an adjustable bracket compliant with VESA mount of a display for securing an input device according to the present invention; and

FIG. 5 shows a rear view of an adjustable bracket according to the present invention with an input device mounted thereon.

### DETAILED DESCRIPTION OF THE PREFERRED EMBODIMENT

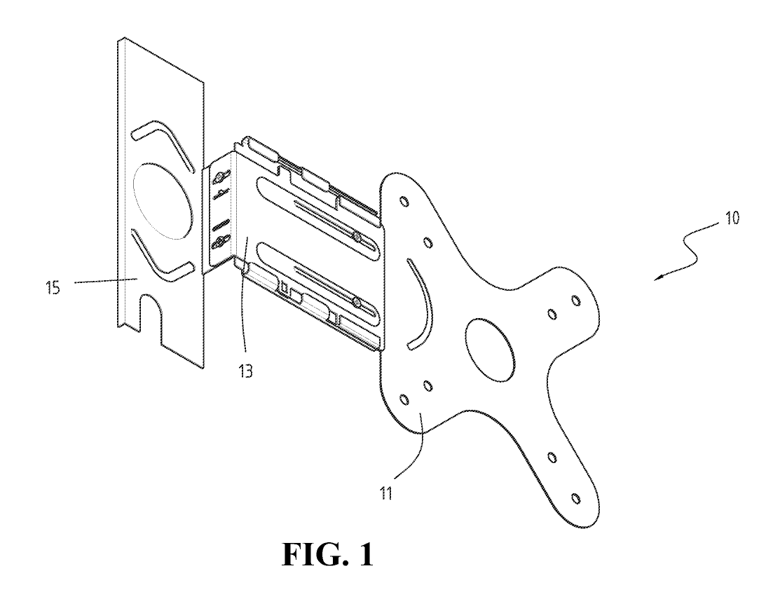

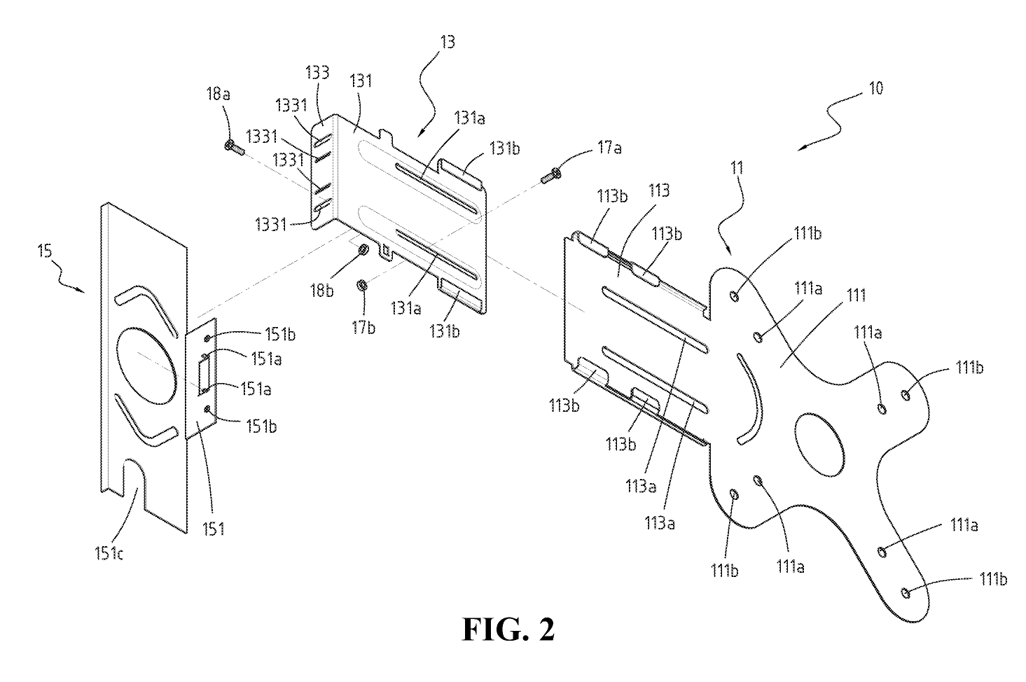

Referring to FIGS. 1, 2 and 3, the adjustable bracket 10 compliant with VESA mount of a display for securing an input device according to the present invention is installed and secured on a VESA mount of a display 20. Besides, the adjustable bracket 10 according to the present invention is provided with functions of left and right sliding, and back and forth sliding, such that the adjustable bracket 10 according to the present invention is compliant with displays with various sizes of screens.

The adjustable bracket 10 according to the present invention comprises: a first arm plate 11, a second arm plate 13, an input device securing plate 15, which are respectively described in the context as follows. The right half plate body of the first arm plate 11 is configured as a securing structure 111. The function of securing structure 111 is to install and secure the adjustable bracket 10 on a VESA mount of a display 20. The securing structure 111 may employ at least one hole 111a, 111b compliant with VESA mount. The distance between adjacent holes 111a or the distance between adjacent holes 111b may employ the distance according to the VESA standard for hole position specification, such as 7.5 cm, 10 cm or 20 cm.

The left half plate body of the first arm plate 11 is configured for a first sliding structure 113, and the main function of the first sliding structure 113 is configured for the second arm plate 13 to slide left and right in the first arm plate 11. The implementation of the first sliding structure 113 may employ a slot structure and a rail structure. The first sliding structure 113 comprises at least one first slot 113a, and at least one first rail 113b. The implementation for each one of first slots 113a is to dig out a penetrating groove in the left half plate body. The implementation for each one of first rails 113b employs the protruded side plates located on upper and lower sides of the first arm plate 11, and bending them into an U-shape structure.

The second arm plate 13 is configured with a second sliding structure 131. The second sliding structure 131 is assembled with the first sliding structure 113. After assembly, the second arm plate 13 can slide left and right in the first arm plate 11. The side of the second arm plate 13 is configured with a third sliding structure 133. The main function of the third sliding structure 133 is configured for the input device securing plate 15 to slide back and forth in the second arm plate 13. Similarly, the implementation for the second sliding structure 131 employs the slot structure and the rail structure. The second sliding structure 131 comprises at least one second slot 131a, and at least one second rail 131b. The implementation for each one of the second slots 131a is to dig out a penetrating groove in the plate body of the second arm plate 13. The second slots 131a are respectively corresponding to these first slots 113a. The implementation for each one of the second rails 131b employs the protruded side plates located on upper and lower sides of the second arm plate 13, and bending into an U-shape structure.

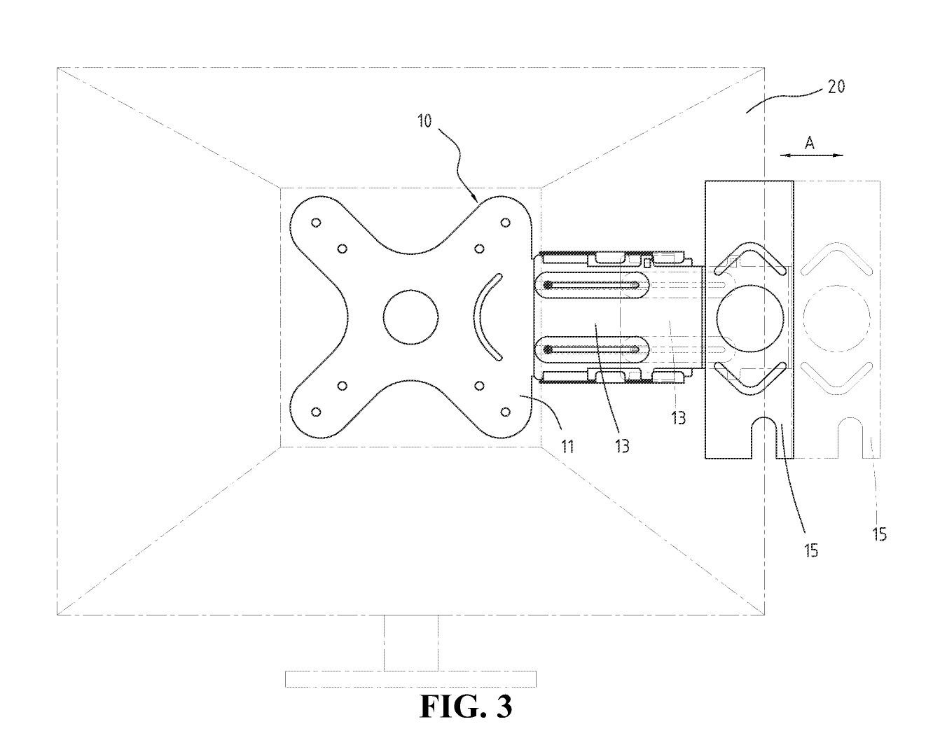

These second rails 131b may be inserted into the U-shape space corresponding to these first rails 113b; then, penetrating the screw 17a through the corresponding first slots 113a and second slots 131a; and screwing the screw 17a with the nut 17b, so as to install the second arm plate 13 on the first arm plate 11. Before the screw 17a and the nut 17b are screwed up for the first arm plate 11 and the second arm plate 13, the second arm plate 13 can slide left and right in the first arm plate 11. Please refer to the double-head arrow A in FIG. 3, which indicates the status of the second arm plate 13 left and right sliding in the first arm plate 11.

The third sliding structure 133 employs the plate body on the side of the second arm plate 13, and bending into a 90 degree, such that the appearance of the second arm plate 13 is approximately a L-shape. The third sliding structure 133 comprises at least one third slot 1331. The implementation for each one of third slots 1331 is to dig out a penetrating groove in the plate body bent into a 90 degree.

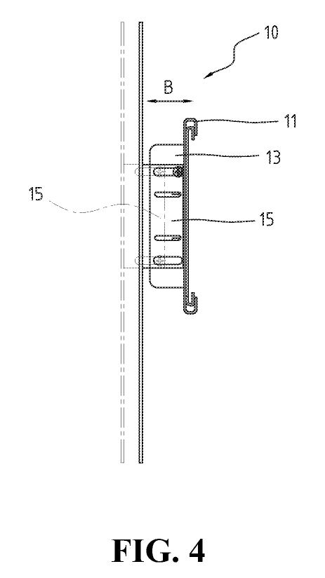

The input device securing plate 15 is used to mount the input device, and configured with a fourth sliding structure 151. The fourth sliding structure 151 is assembled with the third sliding structure 133. After assembly, the input device securing plate 15 can slide back and forth in the second arm plate 13. The fourth sliding structure 151 employs a portion of plate body of the input device securing plate 15 located in the center of one side, and bending into a 90 degree. The fourth sliding structure 151 comprises at least one pins 151a, and at least one through-hole 151b. The pins 151a may be individually inserted into these third slots 1331, and penetrating the screw 18a through the corresponding through-hole 151 and the third slot 1331, and employing the screwing by the nut 18b and the screw 18a, so as to mount the input device securing plate 15 on the second arm plate 13. Before the screw 18a and the nut 18b are screwed up for the input device securing plate 15 and the second arm plate 13, the input device securing plate 15 can slide back and forth in the second arm plate 13. Please refer to the double-head arrow B in FIG. 4, which indicates the status of the input device securing plate 15 sliding back and forth in the second arm plate 13.

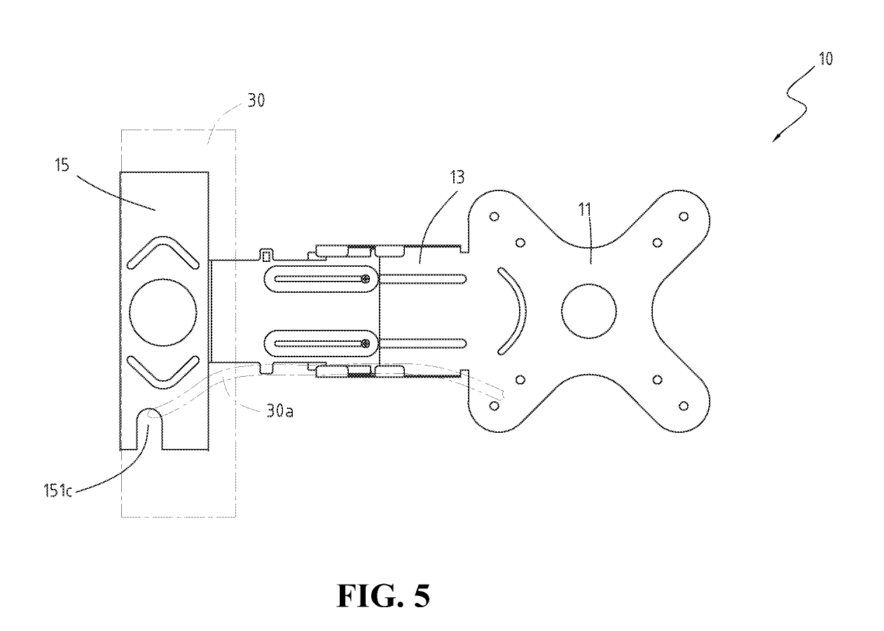

Please refer to FIG. 5. The bottom side of the input device securing plate 15 is configured with an opening 151c, and the opening 151c can be passed through by an electrical cable 30a of the input device 30. The portion of the electrical cable 30a passing through the opening 151c can be accommodated within the first rail 113b and the second rail 131b configured as an U-shape structure. The example for input device 30 may be such as a card swipe, a card reader, a touch panel, a keypad, a fingerprint sensor and the like.

The adjustable bracket 10 according to the present invention may be horizontally placed toward the right and mounted on a display 20. Please refer to FIG. 3, in which the input device securing plate 15 is located on the left side in front of the display 20. Moreover, the adjustable bracket 10 according to the present invention may also be changed to be horizontally placed toward the left and mounted on the display 20, wherein the input device securing plate 15 is located on the right side in front of the display 20; furthermore, or the adjustable bracket 20 of the input device securing plate 15 may also be changed to vertically placed toward the top and mounted on the display 20, wherein the input device securing plate 15 is located on top in the front of the display 20; and, or the adjustable bracket 10 according to the present invention may also be changed to be vertically placed toward the bottom and mounted on the display 20, wherein the input device securing plate 15 is located under in the front of the display 20.

The plate material for the first arm plate 11, the second arm plate 13 and the input device securing plate 15 for the adjustable bracket 10 according to the present invention may be made of the metal material or plastic material.

The adjustable bracket according to the present invention may directly employ the VESA mount of a display for mounting and securing. Besides, the adjustable bracket according to the present invention is provided with functions of left and right sliding and back and forth sliding, so that the adjustable bracket according to the present invention may be compliant with the display having various sizes of screens, which is the substantial improvement by the present invention.

The description provided as above is only the preferred embodiments according to the present invention, which should not be construed limiting the scope of implementation with the present invention. The skilled in the art can obviously make any variations and modifications, which should be construed as not departing from the substantial content of the present invention.

What is claimed is:

1. An adjustable bracket compliant with VESA mount of a display for securing input device, comprises:
a first arm plate, configured for associating with a securing structure of a VESA mount of a display, and having a first sliding structure configured for a second arm plate to slide left and right;
the second arm plate, having a second sliding structure, wherein the second sliding structure is assembled with the first sliding structure, such that the second arm plate can slide left and right in the first arm plate, and a third sliding structure configured for an input device securing plate to slide back and forth;
the input device securing plate, configured for mounting an input device, and having a fourth sliding structure, wherein the fourth sliding structure is assembled with the third sliding structure, such that the input device securing plate can slide back and forth in the second arm plate after assembly.

2. The adjustable bracket compliant with VESA mount of a display for securing input device of claim 1, wherein the securing structure comprises at least one hole compliant with VESA mount.

3. The adjustable bracket compliant with VESA mount of a display for securing input device of claim 1, wherein the first sliding structure comprises at least one first slot and at least one first rail.

4. The adjustable bracket compliant with VESA mount of a display for securing input device of claim 3, wherein each one of the first rails employs the protruded side plate located on upper and lower sides of the first arm plate, and bending into an U-shape structure.

5. The adjustable bracket compliant with VESA mount of a display for securing input device of claim 1, wherein the second sliding structure comprises at least one second slot and at least one second rail, wherein these second slots are respectively corresponding to these first slots.

6. The adjustable bracket compliant with VESA mount of a display for securing input device of claim 5, wherein each one of the second rails employs the protruded side plate located on upper and lower sides of the second arm plate and bending into an U-shape structure, wherein these second rails are inserted into these corresponding first rails.

7. The adjustable bracket compliant with VESA mount of a display for securing input device of claim 1, wherein the third sliding structure is configured on the portion of the plate body of the second arm plate bent into a 90 degree.8. The method for forming the U-shaped metal frame as claimed in claim 7, wherein in the cutting means, rest materials of the first and the second side segments are cut, and the expanding portion of the spaced section is cut so that the billet of the metal frame is separated into the first pipe and a second pipe.

8. The adjustable bracket compliant with VESA mount of a display for securing input device of claim 1, wherein the fourth sliding structure is configured on the portion of the plate body of the input device securing plate bent into a 90 degree.

9. The adjustable bracket compliant with VESA mount of a display for securing input device of claim 1, wherein the third sliding structure comprises at least one third slot, and the fourth sliding structure comprises at least one pin and at least one through-hole, wherein these pins are individually inserted into these corresponding third slots.

10. The adjustable bracket compliant with VESA mount of a display for securing input device of claim 1, wherein the second arm plate is in a L-shape.

11. The adjustable bracket compliant with VESA mount of a display for securing input device of claim 1, wherein the bottom side of the input device securing plate is configured with an opening for passing through the electrical cable of the input device.

12. The adjustable bracket compliant with VESA mount of a display for securing input device of claim 4, wherein a portion of the electrical cable of the input device is accommodated within the first rail and the second rail configured as an U-shape structure.

13. The adjustable bracket compliant with VESA mount of a display for securing input device of claim 6, wherein a portion of the electrical cable of the input device is accommodated within the first rail and the second rail configured as an U-shape structure.
